(19) United States
(12) Patent Application Publication
(10) Pub. No.: US 2025/0194577 A1
(43) Pub. Date: Jun. 19, 2025

(54) Electric Insect Zapper with Integrated Fruit Flies Bait Tray

(71) Applicant: SUNDAY OKPALA-EZECHUKWU, Cochrane (CA)

(72) Inventor: SUNDAY OKPALA-EZECHUKWU, Cochrane (CA)

(21) Appl. No.: 18/542,648

(22) Filed: Dec. 16, 2023

(51) Int. Cl. A01M 1/22; A01M 1/02; A01M 1/04

(52) U.S. Cl. CPC A01M 1/223; A01M 1/023; A01M 1/04

(57) ABSTRACT

Disclosed herein is a novel electric insect zapper design incorporating a UV light source and a specialized fruit flies bait tray. This combination effectively attracts and eliminates a high percentage of fruit flies, offering a more efficient solution compared to traditional bug zappers. The bait tray, placed close to the UV light, uses diced fermenting fruits to specifically target fruit flies, leading to rapid and effective control of these pests in household environments.

### TECHNICAL FIELD

The present invention pertains to the field of pest control devices, specifically an electric bug/insect zapper designed to effectively lure and eliminate fruit flies using a combination of UV light and a specialized fruit flies bait tray.

### BACKGROUND

Conventional bug zappers have been a longstanding solution in the field of pest control, particularly for managing flying insects. These devices utilize ultraviolet (UV) light to attract a broad spectrum of insects, leveraging the natural attraction these pests have to certain light wavelengths. The efficiency of these zappers in luring and eliminating a range of insects has been widely recognized, making them a common fixture in both residential and commercial settings.

Despite their widespread use and general effectiveness, traditional bug zappers exhibit a significant shortcoming in their ability to specifically target fruit flies. Fruit flies, known for their small size and rapid breeding, are a frequent and persistent nuisance in many households. Their presence is often associated with rotting or fermenting organic matter, and they are particularly troublesome in kitchen areas. The standard mechanism of UV light attraction in conventional zappers is not as effective against these tiny pests, as fruit flies do not respond to UV light in the same way as other flying insects.

A key limitation of traditional bug zappers is their reliance on the random approach of fruit flies towards the device. Unlike other insects that are strongly attracted to UV light, fruit flies are less inclined to be drawn to these zappers, leading to inconsistent and often ineffective control of fruit fly infestations. This hit-or-miss approach results in many fruit flies evading capture and continuing to proliferate, thereby failing to offer a reliable solution to the specific problem of fruit fly infestation in homes and businesses.

Therefore, while conventional bug zappers serve as an effective means for controlling a variety of flying insects, their efficacy markedly diminishes when it comes to targeting fruit flies. The limited attraction of fruit flies to UV light, coupled with the random nature of their interaction with these devices, results in a significant gap in pest control. This inadequacy underscores the need for an innovative approach that specifically addresses the unique behaviours and attractions of fruit flies. Such an advancement would not only enhance the effectiveness of bug zappers in domestic and commercial environments but also provide a more comprehensive solution for managing these persistent and bothersome pests.

### SUMMARY

Embodiments of the present disclosure present technological improvements as solutions to one or more of the above-mentioned technical problems recognized by the inventor in conventional solutions.

The present invention discloses an innovative electric insect zapper that significantly improves the effectiveness of fruit fly elimination by integrating a specialized bait tray. This tray is strategically located near the UV light source, enhancing the device's lure capabilities. The combination of UV light and the fruit flies bait tray ensures that fruit flies are irresistibly drawn to the device, leading to their rapid and efficient elimination.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### OBJECT OF INVENTION

One of the objects of the present invention is to enhance fruit fly attraction and elimination efficiency.

Another object of the present invention is to Provide rapid, effective fruit fly control.

Yet another object of the present invention is to Offer user-friendly maintenance and bait replacement.

Another object of the present invention is to increase overall pest control effectiveness in households.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a perspective view of an insect zapper as per the disclosed invention.

FIG. 2 depicts a perspective view of the fruit flies bait tray as per the disclosed invention.

FIG. 3 depicts a cut open view of the fruit flies bait tray as per the disclosed invention.

FIG. 4 depicts a second perspective view of an insect zapper 100 as per the disclosed invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the nonunderlined number is used to identify a general item at which the arrow is pointing.

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

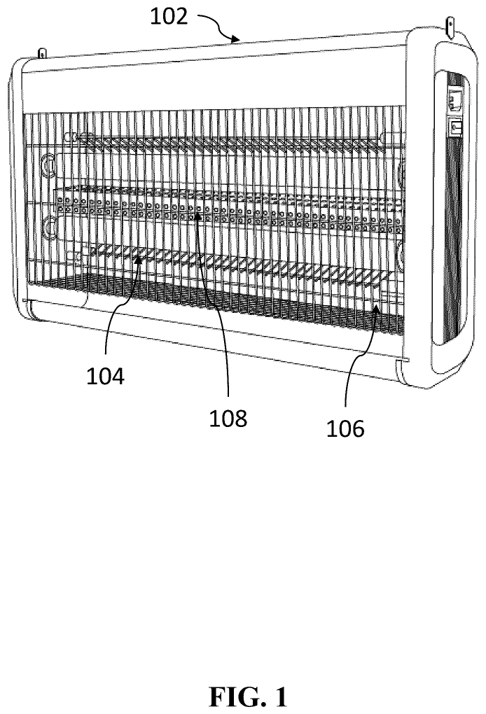

FIG. 1 depicts a perspective view of an insect zapper 100 as per the disclosed invention. The insect zapper 100 comprises a housing 102, a UV light source 104, an electric grid 106, and a fruit flies bait tray 108.

The housing 102 of the insect zapper 100, designed with a focus on durability and environmental resilience, is constructed from high-quality materials. For residential models, a premium grade plastic is often chosen, offering a combination of lightweight convenience and robustness against various weather conditions. This ensures the device remains functional and aesthetically pleasing even after prolonged outdoor exposure. In more demanding settings, such as commercial or industrial areas, a metal housing is preferred for its enhanced strength and longevity. The overall design of the housing 102 emphasizes structural integrity, ensuring it withstands diverse environmental factors like sun exposure, rain, or fluctuating temperatures without compromising its performance or appearance. The housing 102 of the insect zapper 100 adopts a rectangular shape, a design choice that optimizes the internal layout for efficiency and effectiveness. This geometric form allows for a strategic placement of the UV light and electric grid, maximizing the device's insect-attracting capability. The rectangular shape also contributes to the aesthetic appeal of the insect zapper 100, making it a fitting addition to a variety of settings, from modern kitchen interiors to outdoor patios. In terms of dimensions, the insect zapper 100 is crafted to be sufficiently large to house the necessary components for optimal performance, yet compact enough to ensure ease of placement and installation. This balance in size makes it a convenient and portable solution for both indoor and outdoor pest control, adaptable to various environments without being obtrusive.

The UV Light source 104 typically consists of one or more UV bulbs, depending on the size and intended use of the device. These bulbs are carefully selected for their ability to emit a spectrum of light that is particularly attractive to insects, including fruit flies. In models with multiple bulbs, they are arranged in a manner that ensures uniform light distribution, maximizing the device's lure potential. The positioning within the housing is strategic, allowing the light to radiate outwards effectively, drawing insects towards the insect zapper 100 from all directions. The bulbs are designed to emit UV light at a specific wavelength, usually in the range that is most appealing to a wide variety of flying insects such as fruit flies, gnats, houseflies, mosquitoes, moths, ants and various types of flying insects. This wavelength is scientifically determined to be irresistible to pests like fruit flies, moths, and mosquitoes, making the zapper a versatile tool in pest control. The chosen wavelength is key to the device's success, as different insects are attracted to different light frequencies. The selected range ensures that the insect zapper 100 is not just effective for fruit flies but also for other common household and outdoor insects. The intensity of the UV light is calibrated to strike a balance between effectiveness in attracting insects and energy efficiency. This consideration is crucial for ensuring that the zapper can be used for prolonged periods without incurring high electricity costs, especially important for continuous overnight use. The UV bulbs are engineered to consume minimal power while maintaining a high level of performance. This energy-efficient design not only makes the insect zapper 100 cost-effective but also aligns with environmental sustainability practices. The UV bulbs are designed for longevity, reducing the need for frequent replacements. However, they are also easily replaceable, ensuring that maintenance of the insect zapper 100 does not require specialized skills or tools. The bulbs are typically encased in a way that protects them from external elements like rain or dust, further enhancing their durability and ensuring consistent performance over time.

The electric grid 106 is constructed from a highly conductive material, typically a robust metal. This choice of material ensures efficient transmission of electrical current necessary for the insect zapper's functionality. The electric grid 106 is engineered featuring a precise arrangement of metal wires or bars. This design is key to its effectiveness, allowing it to efficiently trap and eliminate insects that come into contact with it. The spacing of the electric grid 106 is an essential aspect of its design. It is calibrated to be small enough to capture and eliminate insects, including small fruit flies, while being sufficiently large to prevent accidental contact by humans. This spacing ensures the primary function of eliminating pests is achieved without posing a risk to people or larger animals. The size of the gaps is carefully considered to create a barrier that insects cannot pass through without being zapped, yet large enough to visibly deter curious fingers or paws, thereby enhancing the safety of the device. The electric grid 106 is charged to a high voltage, which is crucial for instantly eliminating insects upon contact. This high-voltage current is specifically tuned to ensure quick and humane extermination of the pests. Despite its high voltage, the design ensures that the power consumption remains efficient, making the device both effective in pest control and economical in terms of energy usage. In an embodiment, to prevent accidental shocks to humans or pets, the insect zapper 100 includes several safety features. These may include a protective casing or shield around the electrified grid, ensuring that accidental contact is minimized. In yet another embodiment, the insect zapper 100 device is also equipped with safety mechanisms that automatically shut off the grid's power if the protective casing is removed or if the device is tipped over. This adds an extra layer of safety, especially in households with children or pets. The electric grid 106 is designed for durability and low maintenance. It is resistant to rust and corrosion, which is especially important for outdoor use or in humid environments. For cleaning and maintenance, the electric grid 106 can be easily accessed, usually without the need for specialized tools. This allows for the regular removal of insect debris, ensuring the insect zapper 100 remains effective and hygienic over time.

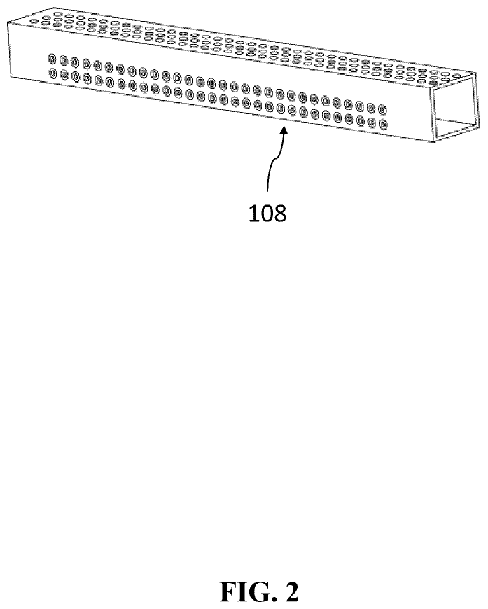

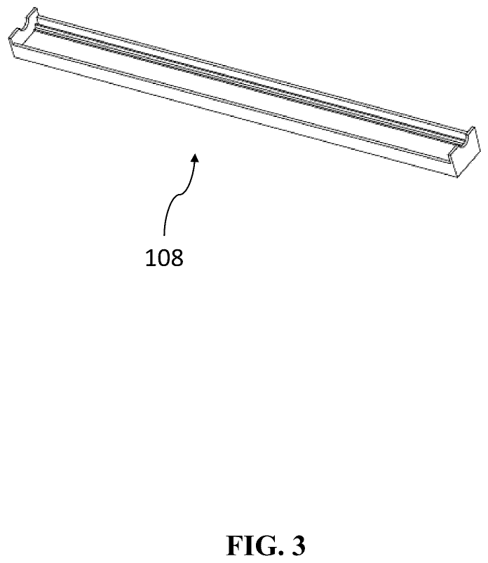

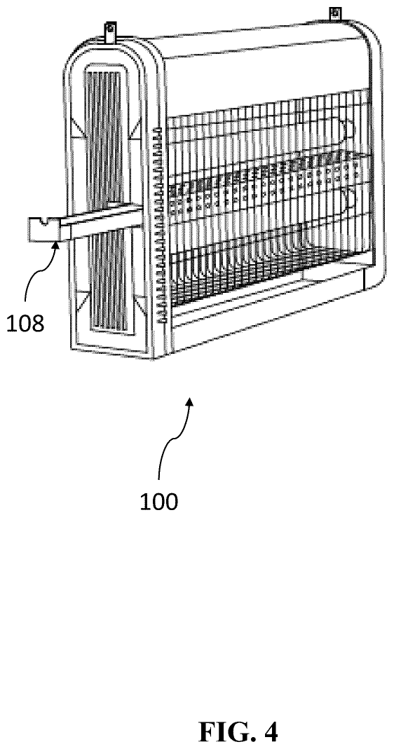

The fruit flies bait tray 108 is situated in close proximity to the UV light source 104 within the insect zapper's housing 102. This strategic placement is crucial for enhancing the attractant effect of the bait in conjunction with the UV light, making it an irresistible lure for fruit flies. The tray 108 is sized to hold a sufficient amount of bait, ensuring its effectiveness over an extended period. It's large enough to contain an ample quantity of diced fermenting fruits or other attractants but compact enough not to be cumbersome within the device's structure. FIG. 2 depicts a perspective view of the fruit flies bait tray as per the disclosed invention. Constructed from materials that are easy to clean and resistant to decay, such as non-corrosive metals or durable plastics, the tray 108 is designed for longevity. This choice of material also ensures hygiene, as it can be easily washed and sanitized, preventing the growth of mold or bacteria. The tray is sized to hold a sufficient amount of bait, ensuring its effectiveness over an extended period. It's large enough to contain an ample quantity of diced fermenting fruits or other attractants but compact enough not to be cumbersome within the device's structure. The bait tray 108 is sized to hold a sufficient amount of bait, ensuring its effectiveness over an extended period. It's large enough to contain an ample quantity of diced fermenting fruits or other attractants but compact enough not to be cumbersome within the device's structure. The bait tray 108 is versatile in accommodating various types of attractants. While diced fermenting fruits are commonly used due to their high efficacy in attracting fruit flies, users have the flexibility to experiment with different baits. FIG. 3 depicts a cut open view of the fruit flies bait tray as per the disclosed invention. This could include other organic matter that fruit flies are drawn to, allowing customization based on specific infestation situations or personal preferences. Furthermore, in some models, the bait tray can either be placed anywhere within the insect zapper such as between the UV bulbs, underneath the UV bulbs or above the UV bulbs. The bait tray 108 is designed with a practical refill mechanism that simplifies the process of replenishing the bait. It could feature a detachable simple slide-out design or a hinged opening, allowing for quick and easy access. FIG. 4 depicts a second perspective view of an insect zapper 100 as per the disclosed invention. This user-friendly aspect ensures that maintaining the effectiveness of the insect zapper 100 is a hassle-free task. This refill mechanism is an integral part of the insect zapper's design, facilitating regular replacement of the bait to ensure continuous and optimal performance. The ease of refilling also encourages regular cleaning of the bait tray 106, which is essential for maintaining sanitary conditions and the overall effectiveness of the insect zapper device. The bait tray 108, while being an integral part of the insect zapper's design, is specifically engineered to be detachable. This means that although the tray is built into the unit to function seamlessly with other components like the UV light and electrified grid, it can be easily removed from the main body of the insect zapper.

In an aspect of the present invention, the insect zapper 100 is designed to be versatile in its power source options. It can be connected to a standard electrical outlet for consistent, uninterrupted operation. This direct power connection is ideal for locations where the insect zapper 100 will be used continuously, such as in kitchens or commercial spaces. Alternatively, in other embodiments, some models are equipped with rechargeable batteries, enhancing the device's portability. This option is particularly beneficial for outdoor use or in areas where an electrical outlet is not readily accessible. The battery-powered models offer flexibility and convenience for users, allowing them to position the insect zapper in the most effective location without being constrained by the need for a nearby power source. Moreover, in some embodiments, the insect zapper power source is controlled by a remote through wireless operation mode.

In yet another aspect of the present invention, a simple on/off switch is provided for easy operation of the insect zapper 100. This switch allows users to activate or deactivate the device as needed, ensuring energy is not wasted when pest control is not required. In other embodiments, the insect zapper 100 may include variable settings that enable users to adjust the intensity of the UV light source 104 and the voltage of the electric grid 106. These adjustable settings provide greater control over the device's performance, allowing it to be tailored to different environmental conditions and specific pest control needs.

In another embodiment, the insect zapper 100 is equipped with hooks or stands to facilitate various placement options. Hooks allow for easy hanging, making it possible to position the device at an optimal height for catching flying insects. Stands provide stability for placing the insect zapper on flat surfaces like tables or shelves.

In yet another embodiment, to enhance safety, particularly in households with children and pets, some models of the insect zapper come with a protective casing around the electrified grid. This casing is designed to prevent accidental contact with the high-voltage grid while maintaining the device's effectiveness in attracting and killing insects.

Optionally, LED indicator lights are incorporated to provide visual cues regarding the operational status of the insect zapper 100. These lights can signal when the device is active and may also indicate when maintenance is needed, such as bait replacement or cleaning. This feature adds convenience for users, ensuring that the insect zapper 100 is always functioning optimally and maintained appropriately.

The below paragraph describes the operation of the insect zapper 100 in detail. When activated via the switch, the insect zapper's UV light source 104 springs to life, emitting a specific wavelength of light that serves as an irresistible attractant to a variety of insects, including fruit flies. This light plays a crucial role in drawing these pests from their surroundings towards the zapper. Simultaneously, the strategically placed bait tray 108 within the device comes into play. Filled with diced fermenting fruits, the bait tray 108 emits a scent that is particularly enticing to fruit flies. This olfactory lure works in tandem with the visual allure of the UV light, creating a dual-attraction mechanism that is especially effective in targeting fruit flies. As these insects, lured by the combined appeal of light and scent, navigate closer to the source, they inevitably come into contact with the electrified grid surrounding the UV light. Upon this contact, the high voltage of the electric grid 106 instantly eliminates the fruit flies, effectively removing these pests from the environment. This operation cycle continues as long as the device is switched on, maintaining a zone of protection against fruit flies and other insects.

The combined lure of the UV light and fermenting fruit bait significantly increases the capture rate of fruit flies, with an efficiency ranging from 75% to 99.99%. Further, this design of insect zapper prevents fruit flies from laying eggs and multiplying, offering a quicker solution compared to conventional zappers. Moreover, the bait tray is easy to access and refill, making the device user-friendly and low-maintenance.

One or more components of the invention are described as unit for the understanding of the specification. Additional or less units can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. The words “device” has been used interchangeably for “insect zapper” disclosed herein. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An electric insect zapper comprising:
a housing;
a UV light source built-in within the housing;
an electrified grid surrounding the UV light source; and
a bait tray located in proximity to the UV light source, designed to hold diced fermenting fruits or similar attractants.

2. The electric insect zapper of claim 1, wherein the bait tray is specifically designed to enhance the luring effectiveness of the zapper for fruit flies.

3. The electric insect zapper of claim 1, wherein the UV light source emits a wavelength that is specifically attractive to a broad range of insects, including fruit flies.

4. The electric insect zapper of claim 1, wherein the electrified grid is energized to a voltage sufficient for eliminating insects upon contact.

5. The electric insect zapper of claim 1, wherein the housing is constructed from a durable, weather-resistant material.

6. The electric insect zapper of claim 1, further comprising a power source configuration that includes either a direct power connection or rechargeable batteries.

7. The electric insect zapper of claim 1, wherein the bait tray is detachable for easy cleaning and refilling.

8. The electric insect zapper of claim 1, further comprising a control mechanism with an on/off switch.

9. The electric insect zapper of claim 8, wherein the control mechanism includes variable settings for adjusting the intensity of the UV light and the voltage of the electric grid.

10. The electric insect zapper of claim 1, further comprising a protective casing around the electrified grid to prevent accidental contact.

11. The electric insect zapper of claim 1, further including indicator lights to show operational status and maintenance needs.

12. The electric insect zapper of claim 1, wherein the housing is designed to facilitate easy mounting or placement in various environments.

13. The electric insect zapper of claim 1, wherein the bait tray is designed to accommodate various types of fruit fly attractants.
